(19) United States
(12) Patent Application Publication
(10) Pub. No.: US 2012/0179466 A1
(43) Pub. Date: Jul. 12, 2012

(54) SPEECH TO TEXT CONVERTING DEVICE AND METHOD

(75) Inventors: YUAN-FU HUANG, Tu-Cheng (TW); TIEN-PING LIU, Tu-Cheng (TW); CHIEN-HUANG CHANG, Tu-Cheng (TW)

(73) Assignee: HON HAI PRECISION INDUSTRY CO., LTD., Tu-Cheng (TW)

(21) Appl. No.: 13/204,960

(22) Filed: Aug. 8, 2011

(30) Foreign Application Priority Data
Jan. 11, 2011 (TW) 100100927

(51) Int. Cl. G10L 15/26

(52) U.S. Cl. 704/235; 704/E15.043

(57) ABSTRACT

A speech to text converting device includes a display, a voice receiving module, a voice recognition module, an identity recognition module, and a control module. The voice receiving module receives a voice signal. The voice recognition module converts the voice signal to voice data and produces text data corresponding to the voice data. The identity recognition module receives the voice signal and establishes an identity data corresponding to the voice signal. The control module displays the text data and the identity data together on the display.

### CROSS-REFERENCE TO RELATED APPLICATIONS

This application is related to co-pending U.S. patent application entitled “SPEECH TO TEXT CONVERTING DEVICE AND METHOD”, Attorney Docket No. US37058, U.S. application Ser. No. ______ filed on ______.

### BACKGROUND

1. Technical Field

The present disclosure relates to speech to text converting devices, and particularly to, a speech to text converting device and a text to speech converting method.

2. Description of Related Art

Speech, or the spoken word, needs be recorded in many fields. However, traditionally a reader cannot know the identity of a speaker when his voice content is converted to text.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of the speech to text converting device.

FIG. 2 is a flow chart in accordance with an embodiment of a speech to text converting method.

FIG. 3 is a flow chart in accordance with an embodiment of the process of step S202 in FIG. 2.

FIG. 4 is a flow chart in accordance with an embodiment of the process of step S203 in FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

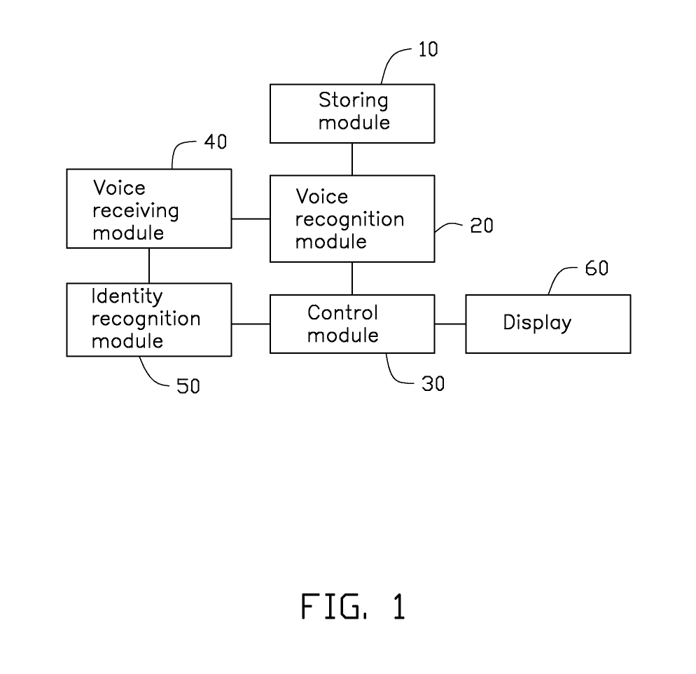

Referring to FIG. 1, a speech to text converting device may be an electronic device and includes a storing module 10, a voice recognition module 20, a control module 30, a voice receiving module 40, an identity recognition module 50, and a display 60. In one embodiment, the voice receiving module 40 is a microphone.

The storing module 10 stores different text data and data as to different human identities which corresponds with passages of speech recorded from each of those different persons. The voice receiving module 40 receives audible speech from an external source. Within a period of time, the recognition module 20 converts the audible speech to voice data and sends text data corresponding to the spoken word to the control module 30. The identity recognition module 50 determines the identity of the speaker who is associated with that particular voice data and sends such identity data from the storing module 10 to the control module 30. The control module 30 displays the text data and the identity data.

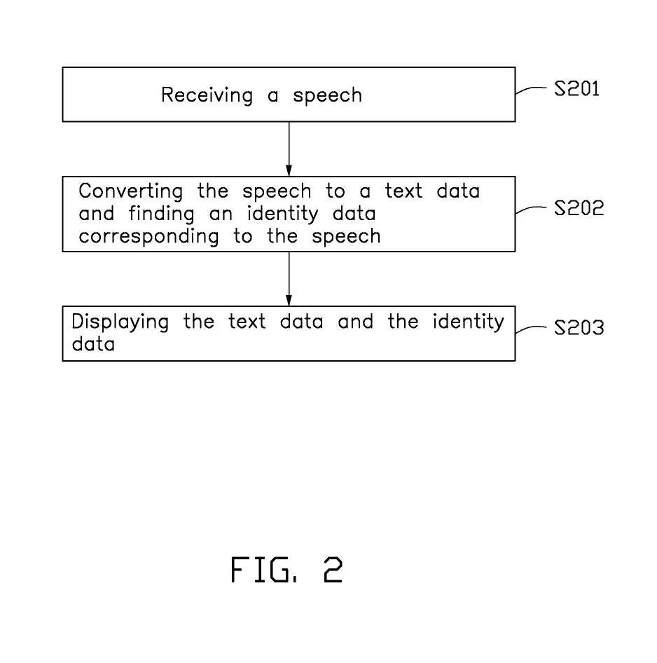

Referring to FIGS. 1 and 2, a speech to text converting method is shown. An embodiment of the method is as follows.

In step S201, the voice receiving module 40 receives audible speech in successive periods of time and sends the speech to the voice recognition module 20 and the identity recognition module 50.

In step S202, the voice recognition module 20 converts the speech to a voice data and sends text data associated with the voice data from the storing module 10 to the control module 30, and the identity recognition module 50 sends data as to the identity of the speaker it has determined to be associated with the speech to the control module 30.

In step S203, the control module 30 displays the text data and the identity data on the display 60.

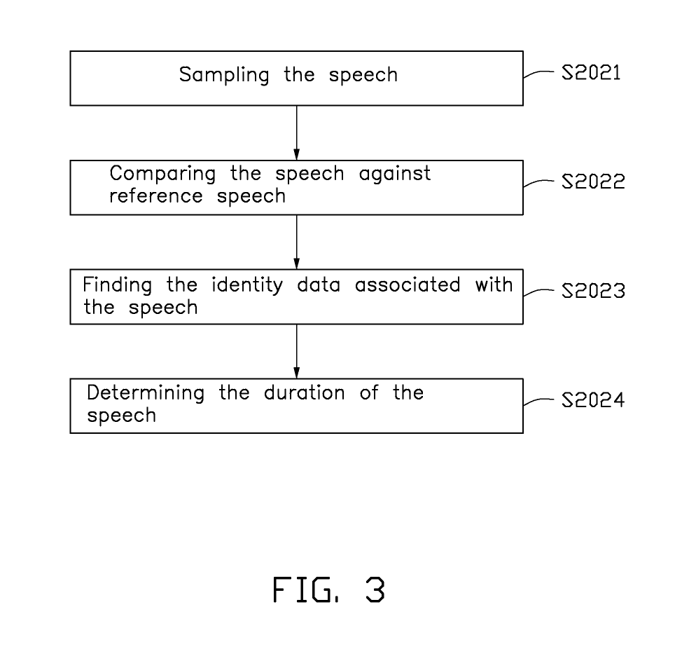

Referring to FIGS. 1 to 3, an embodiment of the process of step S202 in FIG. 2 is as follows.

In step S2021, the identity recognition module 50 samples the speech.

In step S2022, the identity recognition module 50 compares the speech received against different reference speeches from the storing module 10, each reference speech corresponding to an identity.

In step S2023, the identity recognition module 50 looks up the identity data associated with the speech.

In step S2024, the identity recognition module 50 determines the duration of the complete speech and sends the identity data and data as to the duration to the control module 30.

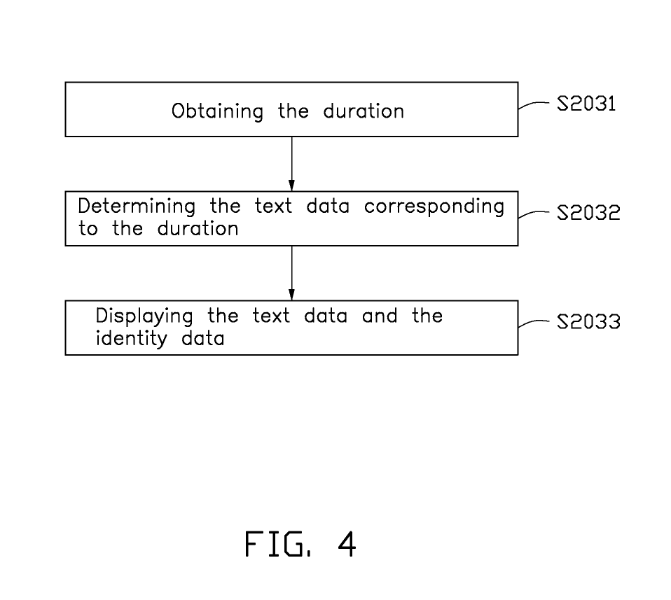

Referring to FIGS. 1, 2, and 4, an embodiment of the process of step S203 in FIG. 2 is as follows.

In step S2031, the control module 30 receives data as to the duration of the complete speech.

In step S2032, the control module 30 determines the particular text data which corresponds throughout to the duration of the complete speech.

In step S2033, the control module 30 displays the identity data and the text data. For example, if the text data is “welcome our manager to give a speech”, and the corresponding identity data is Mr. Green, the display 60 displays “Mr. Green: welcome our manager to give a speech”.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of a method(s) described may be removed, others may be added, and the sequence of steps may be altered. It is also to be understood that the description and the claims drawn for a method may include some indication in reference to certain steps. However, the indication used is only to be viewed for identification purposes and not as a suggestion as to an order for the steps.

What is claimed is:

1. A speech to text converting device, comprising:
a display;
a voice receiving module, the voice receiving module adapted to receive a voice signal;
a voice recognition module, the voice recognition module adapted to convert the voice signal to a voice data and producing a text data corresponding to the voice data;
an identity recognition module, the identity recognition module adapted to receive the voice signal and establish an identity data corresponding to the voice signal after comparing the voice signal with reference voice signals; and
a control module, the control module adapted to display the text data and the identity data on the display after receiving the text data and the identity data.

2. The speech to text converting device of claim 1, wherein the identity recognition module is further adapted to determine a duration of the speech, and the control module is adapted to display the identity data and the text data corresponding to the duration of the speech on the display.

3. The speech to text converting device of claim 1, wherein the voice receiving module is a microphone.

4. A speech to text converting method, applied in a speech to text converting device, the method comprising:
receiving a voice signal;
converting the voice signal to a voice data;
producing a text data associated with the voice data;
establishing an identity data associated with the voice signal; and
displaying the text data and the identity data.

5. The speech to text converting method of claim 4, wherein the establishing the identity data comprises determining a duration of the speech, and the displaying the identity data and the text data comprises displaying the identity data and the text data corresponding to the duration of the speech.

6. The speech to text converting method of claim 5, wherein the receiving the voice signal is captured by a microphone.

7. A speech to text converting method comprising:
providing a display, a voice receiving module, a voice recognition module, an identity recognition module, and a control module;
receiving a voice signal via the voice receiving module;
converting the voice signal to a voice data via the voice recognition module;
producing a text data associated with the voice data via the voice recognition module;
establishing an identity data associated with the voice signal via the identity recognition module; and
displaying the text data and the identity data on the display via the control module.
